(19) United States
(12) Patent Application Publication
(10) Pub. No.: US 2013/0202806 A1
(43) Pub. Date: Aug. 8, 2013

(54) METHOD FOR PRODUCING A MULTI-COAT COLOUR AND/OR EFFECT PAINT SYSTEM, THE COLOUR-FORMING COATING COMPOSITION COMPRISING AN ALKYL-SUBSTITUTED CYCLOALIPHATIC KETONE FOR REDUCING THE PINHOLE COUNT

(71) Applicant: Bernhard Steinmetz, Rutschenhausen (DE)

(72) Inventor: Bernhard Steinmetz, Rutschenhausen (DE)

(73) Assignee: BASF COATINGS GMBH, Munster (DE)

(21) Appl. No.: 13/806,191

(22) PCT Filed: May 30, 2011
(86) PCT No.: PCT/EP2011/058824

§ 371 Date: Feb. 7, 2013

(30) Foreign Application Priority Data
Jul. 1, 2010 (DE) 10 2010 025 769.9

(51) Int. Cl. C09D 175/14; C09D 161/28; C09D 167/00

(52) U.S. Cl. CPC C09D 175/14; C09D 167/00; C09D 161/28
USPC 427/385.5; 524/247

(57) ABSTRACT

The present invention relates to a method for producing a multicoat color and/or effect painting system by
(1) applying a pigmented aqueous basecoat material to a substrate,
(2) forming a polymer film from the coating applied in stage (1),
(3) applying a clearcoat material to the resultant basecoat film, and then
(4) curing the basecoat film together with the clearcoat film.

The method of the invention comprises using in stage (1) a pigmented aqueous basecoat material which comprises at least one alkyl-substituted cycloaliphatic ketone in an amount of 0.1% to 5% by weight, based on the weight of the basecoat material.

The invention relates to a method for producing a multicoat color and/or effect painting system by
(1) applying a pigmented aqueous basecoat material to a substrate,
(2) forming a polymer film from the coating applied in stage (1),
(3) applying a clearcoat material to the resultant basecoat film, and then
(4) curing the basecoat film together with the clearcoat film.

The invention also relates to pigmented aqueous coating materials suitable for producing multicoat color and/or effect paint systems.

The method described above is known (cf., e.g., German patent application DE 199 48 004 A1, page 17, line 37 to page 19 line 22, or German patent DE 100 43 405 C1, column 3, paragraph [0018] and column 8, paragraph [0052] to column 9, paragraph [0057] in conjunction with column 6, paragraph [0039] to column 8, paragraph [0050]) and is widely used, for example, not only for OEM (original) finishing but also for the refinishing of automobile bodies.

The basecoat/clearcoat method in question is used in a wet-on-wet process to produce multicoat color and/or effect paint systems, which particularly in respect of the incidence of pinholes—which are visible as very small holes in clearcoat and basecoat film—are in need of improvement.

The object on which the present invention is based is therefore that of providing a method of the type described above with which multicoat color and/or effect paint systems are obtainable that are improved relative to the paint systems of the prior art. The paint systems are intended in particular to have very few pinholes, or none, and/or an increased pinholing limit. The pinholing limit is that dry film thickness of the basecoat film from which pinholes start to occur.

This object is surprisingly achieved by using in stage (1) of the above-described basecoat/clearcoat method a pigmented aqueous basecoat material which comprises at least one alkyl-substituted cycloaliphatic ketone in an amount of 0.1% to 5% by weight, based on the weight of the basecoat material.

The invention also relates to the pigmented aqueous coating materials described above that can be used in stage (1) of the basecoat/clearcoat method.

In stage (1) of the method of the invention it is possible in principle to use all known aqueous basecoat materials provided they comprise at least one of the above-defined ketones in an amount of 0.1% to 5% by weight, based on the total weight of the basecoat material. Basecoat materials are said to be aqueous when they contain 30% to 70% by weight of water, based on the total weight of the basecoat material. The terms “aqueous basecoat materials” and “waterborne basecoat material” are used as synonymous terms in this specification.

The basecoat materials used in accordance with the invention comprise color and/or effect pigments.

In the method of the invention it is preferred to use basecoat materials which comprise binders curable physically, thermally or both thermally and with actinic radiation. With particular preference at least one saturated or unsaturated polyurethane resin binder is present. Coating materials of this kind that comprise polyurethane resin may likewise typically be cured physically, thermally or both thermally and with actinic radiation.

In the context of the present invention the term “physical curing” denotes the formation of a film by loss of solvent from polymer solutions or polymer dispersions. Normally no crosslinking agents are needed for such curing.

In the context of the present invention the term “thermal curing” denotes the heat-initiated crosslinking of a coating film for which either a separate crosslinking agent and/or self-crosslinking binders are employed. The crosslinking agent comprises reactive functional groups which are complementary to the reactive functional groups present in the binders. This is typically referred to by those in the art as external crosslinking. Where the complementary reactive functional groups or autoreactive functional groups, i.e., groups which react “with themselves”, are already present in the binder molecules, the binders are self-crosslinking. Examples of suitable complementary reactive functional groups and autoreactive functional groups are known from German patent application DE 199 30 665 A1, page 7 line 28 to page 9 line 24.

In the context of the present invention, actinic radiation is understood to encompass electromagnetic radiation such as near infrared (NIR), visible light, UV radiation, X-rays or γ radiation, more particularly UV radiation, and particulate radiation such as electron beams, beta radiation, alpha radiation, proton beams or neutron beams, more particularly electron beams. Curing by UV radiation is typically initiated by free-radical or cationic photoinitiators.

Where thermal curing and curing with actinic light are employed jointly, the term “dual cure” is also used.

The present invention prefers basecoat materials which are curable thermally or both thermally and with actinic radiation, in other words by means of dual cure. Preference is given more particularly to those basecoat materials whose binder is a polyurethane resin and whose crosslinking agent is an amino resin or a blocked or nonblocked polyisocyanate. Among the amino resins, melamine resins are preferred more particularly.

Suitable saturated or unsaturated polyurethane resins are described for example in
German patent application DE 199 11 498 A1, column 1 lines 29 to 49 and column 4 line 23 to column 11 line 5,
German patent application DE 199 48 004 A1, page 4 line 19 to page 13 line 48,
European patent application EP 0 228 003 A1, page 3 line 24 to page 5 line 40,
European patent application EP 0 634 431 A1, page 3 line 38 to page 8 line 9, or
international patent application WO 92/15405, page 2 line 35 to page 10 line 32.

The polyurethane resins preferably contain, for stabilization, alternatively
functional groups which can be converted by neutralizing agents and/or quaternizing agents into cations, and/or cationic groups, or
functional groups which can be converted by neutralizing agents into anions, and/or anionic groups, and/or
nonionic hydrophilic groups.

The polyurethane resins are linear or contain branching points. They may also take the form of graft polymers. In that case they are grafted preferably with acrylate groups. The corresponding acrylate groups are preferably inserted into the polymer following preparation of a primary polyurethane dispersion.

Graft polymers of this kind are well known to the skilled worker and are described for example in DE 199 48 004 A1.

When the basecoat materials that are preferably used take the form of self-crosslinking systems, the polyurethane resin content is 50% to 100%, preferably 50% to 90%, and more preferably 50% to 80%, by weight, based on the film-forming solids of the basecoat material.

By film-forming solids is meant the nonvolatile weight fraction of the coating material, without pigments and/or fillers, that is left as a residue after two hours of drying at 120° C.

In the case of externally crosslinking systems, the polyurethane resin content is between 10% and 80%, preferably between 15% and 75%, and more preferably between 20% and 70%, by weight, based in each case on the film-forming solids of the basecoat material.

It is essential to the invention that the aqueous basecoat material used in stage (1) of the method of the invention comprises at least one alkyl-substituted cycloaliphatic ketone in an amount of 0.1% to 5%, preferably 0.1% to 4.5%, and very preferably 0.2% to 4%, by weight, based on the weight of the basecoat material. The cycloaliphatic ring of the cycloaliphatic ketone contains 5 to 9, preferably 6 to 8, more preferably 6 C atoms and the optionally substituted aliphatic substituent or substituents is/are branched or unbranched alkyl groups having 1 to 20, preferably 1 to 12, more preferably 1 to 6 C atoms. If the ketone content is below 0.1% by weight, the object on which the invention is based is not achieved. If the content is more than 5% by weight, it may be necessary in certain circumstances to accept disadvantages, such as a deterioration of adhesion in unbaked systems, for example.

Ketones used with particular preference are p-tert-butylcyclo-hexanone and methyl-cyclohexanone.

The basecoat materials used in accordance with the invention may further comprise at least one additive. Examples of such additives are salts which can be decomposed thermally without residue, or substantially without residue, crosslinking agents such as the aforementioned amino resins and blocked or nonblocked polyisocyanates, organic solvents, reactive diluents, transparent pigments, fillers, molecularly dispersely soluble dyes, nanoparticles, light stabilizers, antioxidants, deaerating agents, emulsifiers, slip additives, polymerization inhibitors, free-radical polymerization initiators, adhesion promoters, flow control agents, film-forming assistants, sag control agents (SCAs), flame retardants, corrosion inhibitors, waxes, siccatives, biocides, matting agents, and thickeners. Suitable thickeners include inorganic thickeners from the group of the phyllosilicates. Besides the inorganic thickeners, however, it is also possible to use one or more organic thickeners. These are preferably selected from the group consisting of (meth)acrylic acid-(meth)acrylate copolymer thickeners, such as the commercial product Viscalex HV30 (Ciba, BASF), for example, and polyurethane thickeners, such as the commercial product DSX® 1550 from Cognis, for example. (Meth)acrylic acid-(meth)acrylate copolymer thickeners are those which in addition to acrylic acid and/or methacrylic acid also comprise in copolymerized form one or more acrylic esters (i.e., acrylates) and/or one or more methacrylic esters (i.e., methacrylates). A feature common to the (meth)acrylic acid-(meth)acrylate copolymer thickeners is that in alkaline medium, in other words at pH levels >7, more particularly >7.5, they exhibit a sharp rise in viscosity as a result of formation of salts of the acrylic and/or methacrylic acid, in other words by the formation of carboxylate groups. Where (meth)acrylic esters are used that are formed from (meth)acrylic acid and a C1-C6 alkanol, the resulting thickeners are (meth)acrylic acid-(meth)acrylate copolymer thickeners that have a substantially nonassociative action, such as the aforementioned Viscalex HV30, for example. (Meth)acrylic acid-(meth)acrylate copolymer thickeners having a substantially nonassociative action are also referred to in the literature as ASE thickeners (for Alkali Soluble/Swellable Emulsion or dispersion). As (meth)acrylic acid-(meth)acrylate copolymer thickeners it is also possible, however, to use those known as HASE thickeners (Hydrophobically Modified Anionic Soluble Emulsions or dispersions). These are obtained by using, instead of or in addition to the C1-C6 alkanols, alkanols having a larger number of carbon atoms, 7 to 30 for example, or 8 to 20 carbon atoms. The thickening action of HASE thickeners is substantially associative. The (meth)acrylic acid-(meth)acrylate copolymer thickeners that can be used are not suitable as binder resins, on account of their thickening properties; accordingly, they are not included among the binders that are curable physically, thermally or both thermally and actinically, and are therefore explicitly different to the poly(meth)acrylate-based binders that can be used in the basecoat compositions of the invention. Polyurethane thickeners are the thickeners with an associative action that are referred to in the literature as HEUR (Hydrophobically Modified Ethylene Oxide Urethane Rheology Modifiers). In chemical terms these are nonionic, branched or unbranched block copolymers comprising polyethylene oxide chains (in some cases polypropylene oxide chains as well) which are linked to one another via urethane bonds and which carry terminal, long-chain alkyl or alkenyl groups having 8 to 30 carbon atoms. Examples of typical alkyl groups are dodecyl or stearyl groups; an example of a typical alkenyl group is an oleyl group; a typical aryl group is the phenyl group; and an example of a typical alkylated aryl group is a nonylphenyl group. On account of their thickening properties and structure, the polyurethane thickeners are unsuited to the binder resins curable physically, thermally or both thermally and physically. They are therefore explicitly different to the polyurethanes which can be used as binders in the basecoat compositions of the invention.

Suitable additives of the aforementioned kind are known for example from
German patent application DE 199 48 004 A1, page 14 line 4 to page 17 line 5 and
German patent DE 100 43 405 C1, column 5, paragraphs [0031] to [0033].

They are used in the typical and known amounts.

The solids content of the basecoat materials used in accordance with the invention may vary in accordance with the requirements of the case in hand. The solids content is guided primarily by the viscosity that is required for application, especially spray application, and so can be adjusted by the skilled worker on the basis of his or her general art knowledge, where appropriate with assistance from a few range finding tests.

The solids content of the basecoat materials is preferably 5% to 70%, more preferably 10% to 65%, and with particular preference 15% to 60% by weight.

By solids content is meant that weight fraction which is left as a residue on evaporation under defined conditions. In the present specification, the solids content has been determined in accordance with DIN EN ISO 3251. The measurement time was 60 minutes at 125° C.

The basecoat materials used in accordance with the invention can be produced using the mixing assemblies and mixing methods that are typical and known for the production of basecoat materials.

The basecoat materials of the invention may be employed as one-component (1K), two-component (2K) or multicomponent (3K, 4K) systems.

In one-component (1K) systems, binder and crosslinking agent are present alongside one another, i.e., in one component. A prerequisite for this is that the two constituents crosslink with one another only at relatively high temperatures and/or on exposure to actinic radiation.

In two-component (2K) systems, binder and crosslinking agent are present separately from one another in at least two components, which are not combined until shortly before application. This form is selected when binder and crosslinking agent react with one another even at room temperature. Coating materials of this kind are employed in particular for coating thermally sensitive substrates, especially in automotive refinishing.

With the aid of the method of the invention it is possible to coat metallic and nonmetallic substrates, more particularly plastics substrates, preferably automobile bodies or parts thereof.

The invention also provides for the use of the ketones employed in the basecoat materials of the invention for increasing the pinholing limit and/or for reducing the number of pinholes in aqueous pigmented coating materials.

The invention is elucidated below, using examples.

### EXAMPLES

### 1. Preparation of a Silver Waterborne Basecoat Material 1

The components listed in table A under “aqueous phase” are stirred together in the stated order to form an aqueous mixture. In the next step, an organic mixture is prepared from the components listed under “organic phase”. The organic mixture is added to the aqueous mixture. The combined mixture is then stirred for 10 minutes and is adjusted using deionized water and dimethylethanolamine to a pH of 8 and a spray viscosity of 58 mPas under a shearing load of 1000/sec, as measured using a rotational viscometer (Rheomat RM 180 instrument from Mettler-Toledo) at 23° C.

TABLE A

| | Parts by |
|---|---|
| Component | weight |
| Aqueous phase | |
| 3% strength Na Mg phyllosilicate | 26 |
| solution | |
| Deionized water | 3 |
| Butylglycol | 1.75 |
| Polyurethane acrylate; prepared as per | 4.5 |
| page 7 line 55-page 8 line 23 of DE-A- | |
| 4437535 | |
| 20.5% strength by weight solution of DSX | 0.6 |
| 1550 (Cognis), rheological agent | |
| Polyester; prepared as per example D, | 3.2 |
| column 16 lines 37-59 of DE-A-4009858 | |
| Tensid S (BASF), surfactant | 0.3 |
| Butylglycol | 0.55 |
| Cymel 203; melamine-formaldehyde resin, | 4.1 |
| available from Cytec | |
| 10% strength dimethylethanolamine in | 0.3 |
| water | |
| Deionized water | 6 |
| Polyurethane acrylate; prepared as per | 20.4 |
| page 19 line 44-page 20 line 7 of DE- | |
| A-1998004 | |
| Surfynol ® 104, surfactant, from Air | 1.6 |
| Products (in 52% form) | |
| Butylglycol | 0.5 |
| 3% strength by weight aqueous solution | 3.9 |
| of Viscalex HV 30; rheological agent, | |
| available from BASF, in water | |
| Organic Phase | |
| Mixture of two commercial aluminum | 6.2 |
| pigments available from Altana-Eckart | |
| Butylglycol | 7.5 |
| Polyester; prepared as per example D, | 5 |
| column 16, lines 37-59 of DE-A-4009858 | |

### Waterborne Basecoat Material I2

The inventive waterborne basecoat material I2 was prepared by adding 1.5 parts by weight of p-tert-butyl-cyclohexanone to waterborne basecoat material 1.

### Waterborne Basecoat Material I3:

The inventive waterborne basecoat material I3 was prepared by adding 1.5 parts by weight of methylcyclo-hexanone to waterborne basecoat material 1.

TABLE 1
Compositions of waterborne basecoat materials
(WBM) 1 and I2-I3

| WBM | [% by weight] | Ketone |
|---|---|---|
| 1 | — | — |
| I2 | 1.5 | p-tert-butyl-cyclohexanone |
| I3 | 1.5 | methylcyclohexanone |

The weight percentage figures in table 1 relate to the fraction of the ketone in the respective waterborne basecoat material.

### Comparative Experiments Between Waterborne Basecoat Material 1 and Waterborne Basecoat Materials I2 and I3

For determining the pinholing limit and the number of pinholes, the multicoat paint systems were produced in accordance with the following general instructions:

A steel panel coated with a primer-surfacer coating and with dimensions of 30×50 cm was provided on one long edge with an adhesive strip, in order to allow the differences in film thickness to be ascertained after coating. The waterborne basecoat material was applied electrostatically in wedge format. The resulting waterborne basecoat film was flushed at room temperature for a minute and then dried in a forced-air oven at 70° C. for 10 minutes. A typical two-component clearcoat material was applied to the dried waterborne basecoat film. The resulting clearcoat film was flushed at room temperature for 20 minutes. Thereafter the waterborne basecoat film and the clearcoat film were cured in a forced-air oven at 140° C. for 20 minutes. Following visual evaluation of the pinholes in the resultant wedge-shaped multicoat paint system, the film thickness of the pinholing limit was determined. The results are found in table 2.

TABLE 2
Pinholing limit and number of pinholes for
waterborne basecoat material 1 and waterborne basecoat
materials I2 and I3

| WBM | Pinholing limit (μm) | Number of pinholes |
|---|---|---|
| 1 | 11 | 75 |
| I2 | 18 | 1 |
| I3 | 18 | 1 |

The results emphasize the fact that the inventive use of ketones significantly increases the pinholing limit as compared to waterborne basecoat material 1, and at the same time significantly reduces the number of pinholes.

1. A method for producing a multicoat color and/or effect painting system by
(1) applying a pigmented aqueous basecoat material to a substrate,
(2) forming a basecoat polymer film from the pigmented aqueous basecoat material applied in stage (1),
(3) applying a clearcoat material to the basecoat polymer film, and then
(4) curing the basecoat polymer film together with the applied clearcoat material,
wherein the pigmented aqueous basecoat material comprises at least one alkyl-substituted cycloaliphatic ketone in an amount of 0.1% to 5% by weight, based on the weight of the pigmented aqueous basecoat material.

2. The method of claim 1, wherein the cycloaliphatic ketone comprises a cycloaliphatic ring having 5 to 9 carbon (C) atoms and one or more optionally substituted aliphatic substituents are selected from the group consisting of branched or unbranched alkyl groups having 1 to 20 C atoms.

3. The method of claim 1, wherein the pigmented aqueous basecoat material comprises the alkyl-substituted cycloaliphatic ketone selected from the group consisting of p-tert-butylcyclohexanone, methylcyclohexanone, and mixtures thereof.

4. The method of claim 1, wherein the at least one alkyl-substituted cycloaliphatic ketone is present in the pigmented aqueous basecoat material in an amount of from 0.1% to 4.5% by weight, based on the total weight of the pigmented aqueous basecoat material.

5. The method of claim 1, wherein the at least one alkyl-substituted cycloaliphatic ketone is present in the pigmented aqueous basecoat material in an amount of from 0.2% to 4% by weight, based on the total weight of the pigmented aqueous basecoat material.

6. The method of claim 1, wherein the pigmented aqueous basecoat material comprises as binder at least one saturated or unsaturated polyurethane resin.

7. The method of claim 1, wherein the pigmented aqueous basecoat material is curable thermally or both thermally and with actinic radiation.

8. The method of claim 7, wherein the pigmented aqueous basecoat material comprises a crosslinking agent selected from the group consisting of amino resins, blocked polyisocyanates, nonblocked polyisocyanates, and mixtures of two or more of the foregoing.

9. A pigmented aqueous coating material comprising at least one alkyl-substituted cycloaliphatic ketone in an amount of 0.1% to 5% by weight, based on the weight of the pigmented aqueous basecoat material.

10. A method of increasing the pinholing limit and/or for reducing the number of pinholes in aqueous pigmented coating materials, comprising adding one or more alkyl-substituted cycloaliphatic ketones to an aqueous pigmented coating material.

11. The method of claim 2, wherein the cycloaliphatic ketone comprises a cycloaliphatic ring having 6 to 8 C atoms and the one or more optionally substituted aliphatic substituents are selected from the group consisting of branched or unbranched alkyl groups having 1 to 12 C atoms.

12. The method of claim 11 wherein the cycloaliphatic ketone comprises a cycloaliphatic ring having 6 carbon (C) atoms and the one or more optionally substituted aliphatic substituents are selected from the group consisting of branched or unbranched alkyl groups having 1 to 6 C atoms.
